(19) United States
(12) Patent Application Publication
(10) Pub. No.: US 2023/0391027 A1
(43) Pub. Date: Dec. 7, 2023

(54) TREATING THREE-DIMENSIONAL PRINTED OBJECTS WITH LIQUID OIL

(71) Applicant: Hewlett-Packard Development Company, L.P., Spring, TX (US)

(72) Inventors: EMRE HIRO DISCEKICI, SAN DIEGO, CA (US); ALAY YEMANE, SAN DIEGO, CA (US)

(21) Appl. No.: 18/034,294

(22) PCT Filed: Nov. 25, 2020
(86) PCT No.: PCT/US2020/062373

§ 371 Date: Apr. 27, 2023

(51) Int. Cl. B29C 71/00; B29C 64/30

(52) U.S. Cl. CPC B29C 71/0009; B29C 64/30; B33Y 30/00

(57) ABSTRACT

The present disclosure includes a three-dimensional printing kit having a fusing agent with from about 75 wt % to about 99 wt % water, and from about 0.1 wt % to about 15 wt % radiation absorber. The three-dimensional printing kit can further include a polymeric build material including polyamide-12 particles, and a liquid oil comprising from about 50 wt % to 100 wt % of a long-chain molecule having a carbon chain of about C₁₂ to about C₁₀₀.

### BACKGROUND

Methods of three-dimensional (3D) digital printing, a type of additive manufacturing, have continued to be developed over the last few decades. However, systems for three-dimensional printing have historically been expensive, though those expenses have been coming down to more affordable levels recently. Three-dimensional printing technology can shorten the product development cycle by allowing rapid creation of prototype models for reviewing and testing. Unfortunately, the concept has been somewhat limited with respect to commercial production capabilities because the range of materials used in three-dimensional printing is likewise limited. Accordingly, it can be a challenge to three-dimensionally print functional parts with desired mechanical properties. Nevertheless, several commercial sectors such as aviation and the medical industry have benefitted from the ability to rapidly prototype and customize parts for customers.

### BRIEF DESCRIPTION OF THE DRAWINGS

FIG. 1 is a schematic view of an example three-dimensional printing kit in accordance with the present disclosure.

FIG. 2 is a schematic view of an example three-dimensional printed object being treated with liquid oil in accordance with the present disclosure.

FIG. 3 is a cross-sectional view of an example three-dimensional object prepared in accordance with the present disclosure.

FIG. 4 is a flow diagram illustrating an example method of treating a three-dimensional object in accordance with the present disclosure.

FIGS. 5A-5C are schematic views of an example three-dimensional printing system in accordance with the present disclosure.

### DETAILED DESCRIPTION

The present disclosure describes three-dimensional printing kits, three-dimensional printed objects, and methods of making three-dimensional printed objects. In one example, a three-dimensional printing kit can include a fusing agent having from about 75 wt % to about 99 wt % water, and from about 0.1 wt % to about 15 wt % radiation absorber. The three-dimensional printing kit can further include a polymeric build material including polyimide-12 particles and a liquid oil comprising from about 50 wt % to 100 wt % of a long-chain molecule having a carbon chain of about C₁₂ to about C₁₀₀. In one example, the liquid oil can include a C₁₂ to about C₁₀₀ straight-chain alkane, a C₁₂ to about C₁₀₀ branched alkane, a silicone oil having an alkyl side group, or a combination thereof. In another example, the liquid oil can include from about 50 wt % to 100 wt % of a C₁₈ to about C₄₈ alkane or a polydimethylsiloxane. The radiation can be selected from carbon black pigment, metal dithiolene complex, a near-infrared absorbing dye, a near-infrared absorbing pigment, metal nanoparticles, a conjugated polymer, tungsten bronze, molybdenum bronze, or a combination thereof.

In another example, a three-dimensional printed object can include a polymeric body including fused polyimide-12 particles having radiation absorber embedded as particles among the fused polyimide-12 particles. A liquid oil can be soaked into a surface of the polymeric body. The liquid oil can include a long-chain molecule having a carbon chain of about C₁₂ to about C₁₀₀. The three-dimensional printed object in this example can exhibit a percent strain at break that is more than twice that of a control three-dimensional printed object prepared identically but without soaking in the liquid oil. In further detail, the liquid oil can be soaked into a surface of a three-dimensional printed object at a temperature from about 0° C. to about 150° C. for a period of time of about 4 hours to about 1 month. In another example, the three-dimensional printed object can exhibit a 150% strain at break or greater after soaking,

In another example, a method of enhancing the ductility of a three-dimensional printed object can include soaking a three-dimensional printed object in a liquid oil at a temperature from about 0° C. to about 150° C. for a period of time of about 4 hours to about 1 month. The liquid oil can include a long-chain molecule having a carbon chain of about C₁₂ to about C₁₀₀ . The three-dimensional printed object can include fused polyimide-12 particles having radiation absorber embedded as particles among the fused polyamide-12 particles. In one example, the liquid oil can include a C₁₂ to about C₁₀₀ straight-chain alkane, a C₁₂ to about C₁₀₀ branched alkane, a silicone oil having an alkyl side group, or a combination thereof. In another example, the radiation absorber can be selected from carbon black pigment, metal dithiolene complex, a near-infrared absorbing dye, a near-infrared absorbing pigment, metal nanoparticles, a conjugated polymer, tungsten bronze, molybdenum bronze, or a combination thereof. The three-dimensional printed object can include the radiation absorber in an amount from about 0.005 wt % to about 5 wt % with respect to the total weight of the three-dimensional printed object. The three-dimensional printed object can likewise exhibit a percent strain at break that is more than twice that of a control three-dimensional printed object prepared identically but without soaking in the liquid oil. In one example, the method can further include washing the surface of the three-dimensional printed object after applying the liquid oil. The liquid oil, in another example, can be applied at a temperature from about 15° C. to about 35° C. Regarding preparation of the three-dimensional printed object, the object can be prepared by iteratively applying individual build material layers of polyimide-12 particles to a powder bed, and based on a three-dimensional object model, selectively applying a fusing agent onto the individual build material layers, wherein the fusing agent comprises water and the radiation absorber. The preparation of the three-dimensional object can further include exposing the powder bed to energy to selectively fuse the polyimide-12 particles in contact with the radiation absorber to form the fused polyimide-12 particles having the radiation absorber embedded as particles at individual build material layers. Once the three-dimensional object is formed, the method can include soaking the three-dimensional printed object in the liquid oil, for example.

Terms used herein will have the ordinary meaning in their technical field unless specified otherwise. In some instances, there are terms defined more specifically throughout the specification or included at the end of the present specification, and thus, these terms can have a meaning as described herein.

### Three-dimensional Printing Kits

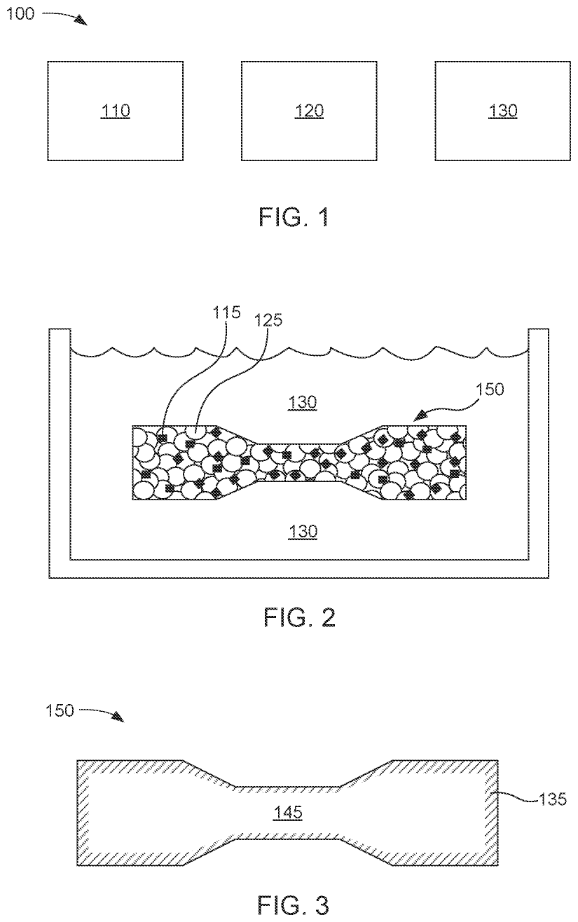

The present disclosure also describes three-dimensional printing kits. The kits can include materials used in the methods and in forming the three-dimensional printed objects described hereinafter. FIG. 1 shows a schematic illustration of one example three-dimensional printing kit 100 in accordance with examples of the present disclosure. The kit includes a particulate build material of a fusing agent 110, polyimide-12 particles 120, and a liquid oil 130. In some examples, the fusing agent can include from about 75 wt % to about 99 wt % water, and a radiation absorber, which can be in the form of particles dispersed therein at a concentration from about 0.1 wt % to about 15 wt % by solids weight, based on a total weight of the fusing agent. The polyimide-12 particles can be suitable for use as a particulate build material in the methods described herein. Further details about the composition of the fusing agent and the polyimide-12 particles are described in greater detail below. The liquid oil can include a long-chain molecule having a carbon chain (branched or straight-chained) from about C₁₂ to about C₁₀₀ , from about C₁₂ to about C₄₈, from about C₁₂ to about C₃₄, from about C₁₈ to about C₄₈, or from about C₁₈ to about C₃₄, for example. In one example, the liquid oil can include from about 50 wt % to 100 wt % of a C₁₂ to about C₁₀₀ straight-chain alkane, a C₁₂ to about C₁₀₀ branched alkane, a silicone oil having an alkyl side group, e.g., C₁₂ to about C₁₀₀ carbon atoms, or a combination thereof. Again, more details regarding the liquid oil are provided hereinafter.

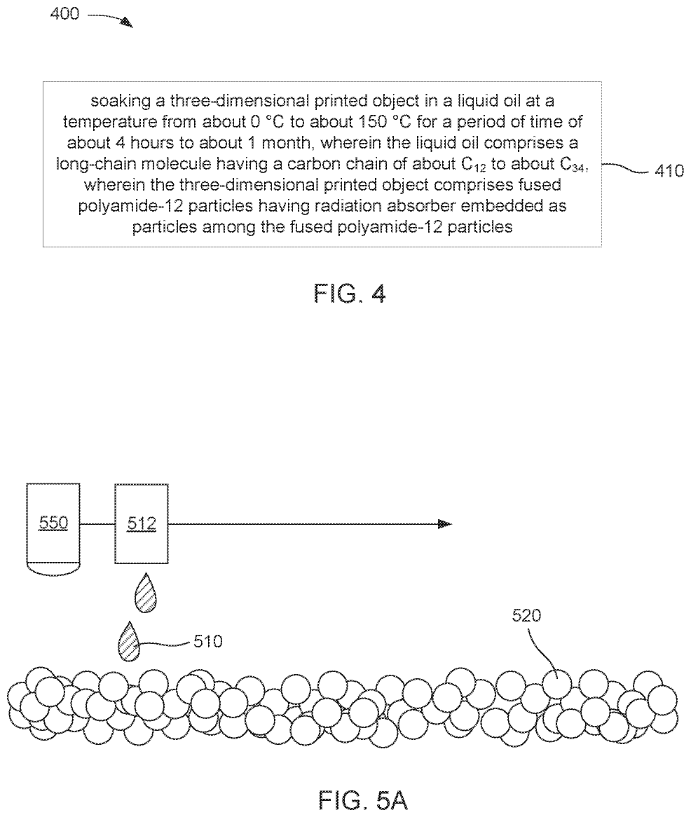

FIG. 2 illustrates an example where the three-dimensional printing kit (and methods described herein) is used to prepare a three-dimensional object. In this example, the three-dimensional printed object 150 is shown as being treated with a liquid oil 130. The three-dimensional printed object is made up of fused polyimide-12 particles 125 and radiation absorber 115 particles embedded among the fused polyimide-12 particles. The three-dimensional object can be prepared as shown and described in FIGS. 4A-4C hereinafter, for example. In this particular example, the liquid oil is applied to the surface of the three-dimensional printed object by dipping the three-dimensional printed object in the liquid oil. However, the soaking can be by other methodologies, such as dipping the three-dimensional object in the liquid oil, spraying the three-dimensional printed object with the oil, brushing the three-dimensional object, etc., provided the oil remains in contact with the surface of the three-dimensional object during the duration of the soak.
Particulate Build Materials

In further detail regarding the particulate build material, e.g., which includes the polyamide-12 particles, this material can include polyamide-12 particles having a variety of shapes, such as substantially spherical particles or irregularly-shaped particles. In some examples, the polyamide-12 particles can be capable of being formed into three-dimensional printed objects with a resolution of about 20 μm to about 100 μm, about 30 μm to about 90 μm, or about 40 μm to about 80 μm. As used herein, “resolution” refers to the size of the smallest feature that can be formed on a three-dimensional printed object. The polyamide-12 particles can form layers from about 20 μm to about 100 μm thick, allowing the fused layers of the printed part to have roughly the same thickness. This can provide a resolution in the z-axis (i.e., depth) direction of about 20 μm to about 100 μm. The polyamide-12 particles can also have a sufficiently small particle size and sufficiently regular particle shape to provide about 20 μm to about 100 μm resolution along the x-axis and y-axis (i.e., the axes parallel to the top surface of the powder bed). For example, the polyimide-12 particles can have an average particle size from about 20 μm to about 100 μm. In other examples, the average particle size can be from about 20 μm to about 50 μm. Other resolutions along these axes can be from about 30 μm to about 90 μm or from 40 μm to about 80 μm.

The polyamide-12 particles can have a melting or softening point from about 175° C. to about 200° C. If other polymeric particles are included in the particulate build material, e.g., blended or composited with the polyamide-12 particles, examples of materials that may be present include particles of polyimide-6, polyimide-9, polyimide-11, polyimide-6,6, polyimide-6,12, polyamide copolyamide-12, polyethylene, wax, thermoplastic polyurethane, acrylonitrile butadiene styrene, amorphous polyamide, polymethylmethacrylate, ethylene-vinyl acetate, polyarylate, aromatic polyesters, silicone rubber, polypropylene, polyester, polycarbonate, copolymers of polycarbonate with acrylonitrile butadiene styrene, copolymers of polycarbonate with polyethylene terephthalate, polyether ketone, polyacrylate, polystyrene, polyvinylidene fluoride, polyvinylidene fluoride copolyamide-12, poly(vinylidene fluoride-trifluoroethylene), poly(vinylidene fluoride-trifluoroethylene-chlorotrifluoroethylene), or mixtures thereof. If a second type of polymer particle is included, in one example, the majority of the polymeric particles present can be polyamide-12, e.g., greater than 50 wt % of the polymer particles present in the particulate build material includes polyamide-12. In other examples, when multiple polymer particles are used, a weight ratio of polyamide-12 to all other polymer particles present can be from about 100:1 to about 1:1, or from about 20:1 to about 2:1, for example.

The polyamide-12 particles can also in some cases be blended with a non-polymeric filler. The filler can include inorganic particles such as alumina, silica, fibers, carbon nanotubes, or combinations thereof. When the polyamide-12 particles fuse together, the filler particles can become embedded in the polymer forming a composite material. In some examples, the filler can include a free-flow agent, anti-caking agent, or the like. Such agents can prevent packing of the powder particles, coat the powder particles and smooth edges to reduce inter-particle friction, and/or absorb moisture. In further examples, a filler can be encapsulated in polymer to form polymer encapsulated particles. For example, glass beads can be encapsulated in a polymer such as a polyamide to form polymer encapsulated particles. In some examples, a weight ratio of thermoplastic polymer to filler in the particulate build material can be from about 100:1 to about 1:2 or from about 5:1 to about 1:1.
Fusing Agents

In more specific detail regarding the fusing agent, these fusing agents can be applied to the particulate build in areas that are to be fused together during three-dimensional printing. The fusing agent can include carbon black pigment particles as a radiation absorber. The carbon black pigment particles can absorb radiant energy and convert the energy to heat. As explained above, the fusing agent can be used with a particulate build material in a particular three-dimensional printing process. A thin layer of particulate build material can be formed, and then the fusing agent can be selectively applied to areas of the particulate build material that are desired to be consolidated to become part of the solid three-dimensional printed object. The fusing agent can be applied, for example, by printing such as with a fluid ejector or fluid jet printhead. Fluid jet printheads can jet the fusing agent in a similar way as an inkjet printhead jetting ink. Accordingly, the fusing agent can be applied with great precision to certain areas of the particulate build material that are desired to form a layer of the final three-dimensional printed object. After applying the fusing agent, the particulate build material can be irradiated with radiant energy. The carbon black pigment particles from the fusing agent can absorb this energy and convert it to heat, thereby heating any polyimide-12 particles in contact with the pigment particles. An appropriate amount of radiant energy can be applied so that the area of the particulate build material that was printed with the fusing agent heats up enough to melt the polyimide-12 particles to consolidate the particles into a solid layer, while the particulate build material that was not printed with the fusing agent remains as a loose powder with separate particles.

In some examples, the amount of radiant energy applied, the amount of fusing agent applied to the powder bed, the concentration of radiation absorber in the fusing agent, and the preheating temperature of the powder bed (e.g., the temperature of the particulate build material prior to printing the fusing agent and irradiating) can be tuned to ensure that the portions of the powder bed printed with the fusing agent will be fused to form a solid layer and the unprinted portions of the powder bed will remain a loose powder. These variables can be referred to as parts of the “print mode” of the three-dimensional printing system. The print mode can include any variables or parameters that can be controlled during three-dimensional printing to affect the outcome of the three-dimensional printing process.

The process of forming a single layer by applying fusing agent and irradiating the powder bed can be repeated with additional layers of fresh particulate build material to form additional layers of the three-dimensional printed object, thereby budding up the final object one layer at a time. In this process, the particulate build material surrounding the three-dimensional printed object can act as a support material for the object. When the three-dimensional printing is complete, the article can be removed from the powder bed and any loose powder on the article can be removed.

Accordingly, in some examples, the fusing agent can include a radiation absorber that is capable of absorbing electromagnetic radiation to produce heat. The radiation absorber can include carbon black pigment particles. These particles can effectively absorb radiation to generate heat. The particles also give the finished three-dimensional printed object a black appearance. In further examples, additional radiation absorbers may also be included. The radiation absorbers can be colored or colorless. In various examples, the radiation absorber can include carbon black pigment, metal dithiolene complex, a near-infrared absorbing dye, a near-infrared absorbing pigment, metal nanoparticles, a conjugated polymer, tungsten bronze, molybdenum bronze, or a combination thereof. Examples of near-infrared absorbing dyes include aminium dyes, tetraaryldiamine dyes, cyanine dyes, pthalocyanine dyes, dithiolene dyes, and others. In further examples, the radiation absorber can be a near-infrared absorbing conjugated polymer such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof. As used herein, “conjugated” refers to alternating double and single bonds between atoms in a molecule. Thus, “conjugated polymer” refers to a polymer that has a backbone with alternating double and single bonds. In many cases, the radiation absorber can have a peak absorption wavelength in the range of about 800 nm to about 1400 nm.

A variety of near-infrared pigments can also be used. Non-limiting examples can include phosphates having a variety of counterions such as copper, zinc, iron, magnesium, calcium, strontium, the like, and combinations thereof. Non-limiting specific examples of phosphates can include M₂P₂O₇, M₄P₂O₉, M₅P₂O₁₀, M₃(PO₄)₂, M(PO₃)₂, M₂P₄O₁₂, and combinations thereof, where M represents a counterion having an oxidation state of +2, such as those listed above or a combination thereof. For example, M₂P₂O₇ can include compounds such as Cu₂P₂O₇, Cu/MgE₂O₇, Cu/ZnP₇O₇, or any other suitable combination of counterions. It is noted that the phosphates described herein are not limited to counterions having a +2 oxidation state. Other phosphate counterions can also be used to prepare other suitable near-infrared pigments.

Additional near-infrared pigments can include silicates. Silicates can have the same or similar counterions as phosphates. One non-limiting example can include M₂SiO₄, M₂Si₂O₆, and other silicates where M is a counterion having an oxidation state of +2. For example, the silicate M₂Si₂O₆ can include Mg₇Si₂O₆, Mg/CaSi₂O₆, MgCuSi₂O₆, Cu₂Si₂O₆, Cu/ZnSi₂O₆, or other suitable combination of counterions. It is noted that the silicates described herein are not limited to counterions having a +2 oxidation state. Other silicate counterions can also be used to prepare other suitable near-infrared pigments.

In further examples, the radiation absorber can include a metal dithiolene complex. Transition metal dithiolene complexes can exhibit a strong absorption band in the 600 nm to 1600 nm region of the electromagnetic spectrum. In some examples, the central metal atom can be any metal that can form square planer complexes. Non-limiting specific examples include complexes based on nickel, palladium, and platinum.

In further examples, the radiation absorber can include a tungsten bronze or a molybdenum bronze. In certain examples, tungsten bronzes can include compounds having the formula MₓWO₃, where M is a metal other than tungsten and x is equal to or less than 1. Similarly, in some examples, molybdenum bronzes can include compounds having the formula MₓMoO₃, where M is a metal other than molybdenum and x is equal to or less than 1.

A dispersant can be included in the fusing agent in some examples. Dispersants can help disperse the radiation absorbing pigments described above. In some examples, the dispersant itself can also absorb radiation. Non-limiting examples of dispersants that can be included as a radiation absorber, either alone or together with a pigment, can include polyoxyethylene glycol octylphenol ethers, ethoxylated aliphatic alcohols, carboxylic esters, polyethylene glycol ester, anhydrosorbitol ester, carboxylic amide, polyoxyethylene fatty acid amide, poly (ethylene glycol) p-isooctyl-phenyl ether, sodium polyacrylate, and combinations thereof.

The amount of radiation absorber in the fusing agent can vary depending on the type of radiation absorber. In some examples, the concentration of radiation absorber in the fusing agent can be from about 0.1 wt % to about 20 wt %. In one example, the concentration of radiation absorber in the fusing agent can be from about 0.1 wt % to about 15 wt %. In another example, the concentration can be from about 0.1 wt % to about 8 wt %. In yet another example, the concentration can be from about 0.5 wt % to about 2 wt %. In a particular example, the concentration can be from about 0.5 wt % to about 1.2 wt %. In one example, the radiation absorber can have a concentration in the fusing agent such that after the fusing agent is jetted onto the polyimide-12 particles, the amount of radiation absorber in the polyimide-12 particles can be from about 0.0003 wt % to about 10 wt %, or from about 0.005 wt % to about 5 wt %, with respect to the weight of the polyimide-12 particles,

In some examples, the fusing agent can be jetted onto the polyimide-12 particle build material using a fluid jetting device, such as inkjet printing architecture. Accordingly, in some examples, the fusing agent can be formulated to give the fusing agent good jetting performance. Ingredients that can be included in the fusing agent to provide good jetting performance can include a liquid vehicle. Thermal jetting can function by heating the fusing agent to form a vapor bubble that displaces fluid around the bubble, and thereby forces a droplet of fluid out of a jet nozzle. Thus, in some examples the liquid vehicle can include a sufficient amount of an evaporating liquid that can form vapor bubbles when heated. The evaporating liquid can be a solvent such as water, an alcohol, an ether, or a combination thereof.

In some examples, the liquid vehicle formulation can include a co-solvent or co-solvents present in total at from about 1 wt % to about 50 wt %, depending on the jetting architecture. Further, a non-ionic, cationic, and/or anionic surfactant can be present, ranging from about 0.01 wt % to about 5 wt %, In one example, the surfactant can be present in an amount from about 1 wt % to about 5 wt %. The liquid vehicle can include dispersants in an amount from about 0.5 wt % to about 3 wt %. The balance of the formulation can be purified water, and/or other vehicle components such as biocides, viscosity modifiers, material for pH adjustment, sequestering agents, preservatives, and the like. In one example, the liquid vehicle can be predominantly water.

In some examples, a water-dispersible or water-soluble radiation absorber can be used with an aqueous vehicle. Because the radiation absorber is dispersible or soluble in water, an organic co-solvent may not be present, as it may not be included to solubilize the radiation absorber. Therefore, in some examples the fluids can be substantially free of organic solvent, e.g., predominantly water. However, in other examples a co-solvent can be used to help disperse other dyes or pigments or enhance the jetting properties of the respective fluids. In still further examples, a non-aqueous vehicle can be used with an organic-soluble or organic-dispersible fusing agent.

Classes of co-solvents that can be used can include organic co-solvents including aliphatic alcohols, aromatic alcohols, dials, glycol ethers, polyglycol ethers, caprolactams, formamides, acetamides, and long chain alcohols. Examples of such compounds include 1-aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include, but are not limited to, 2-pyrrolidinone, N-methylpyrrolidone, 2-hydroxyethyl-2-pyrrolidone, 2-methyl-1,3-propanediol, tetraethylene glycol, 1,5-hexanediol, 1,5-hexanediol, 1,2-propanediol, and 1,5-pentanedial.

In certain examples, a high boiling point co-solvent can be included in the fusing agent. The high boiling point co-solvent can be an organic co-solvent that boils at a temperature higher than the temperature of the powder bed during printing. In some examples, the high boiling point co-solvent can have a boiling point above about 250° C. In still further examples, the high boiling point co-solvent can be present in the fusing agent at a concentration from about 1 wt % to about 4 wt %.

In certain examples, the fusing agent can include a polar organic solvent. As used herein, “polar organic solvents” can include organic solvents made up of molecules that have a net dipole moment or in which portions of the molecule have a dipole moment, allowing the solvent to dissolve polar compounds. The polar organic solvent can be a polar protic solvent or a polar aprotic solvent. Examples of polar organic solvents that can be used can include diethylene glycol, triethylene glycol, tetraethylene glycol, C3 to C6 diols, 2-pyrrolidone, hydroxyethyl-2-pyrrolidone, 2-methyl-1,3 propanediol, polypropylene glycol) with 1, 2, 3, or 4 propylene glycol units, glycerol, and others. In some examples, the polar organic solvent can be present in an amount from about 0.1 wt % to about 20 wt % with respect to the total weight of the fusing agent.

Regarding the surfactant that may be present, a surfactant or surfactants can be used, such as alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the fusing agent may range from about 0.01 wt % to about 20 wt %. Suitable surfactants can include, but are not limited to, liponic esters such as TERGITOL™ 15-S-12, TERGITOL™ 15-S-7 available from Dow Chemical Company (Michigan), LEG-1 and LEG-7; TRITON™ X-100; TRITON™ X-405 available from Dow Chemical Company (Michigan); and sodium dodecylsulfate.

Various other additives can be employed to enhance certain properties of the fusing agent for specific applications. Examples of these additives are those added to inhibit the growth of harmful microorganisms. These additives may be biocides, fungicides, and other microbial agents, which can be used in various formulations. Examples of suitable microbial agents include, but are not limited to, NUOSEPTO (Nudex, Inc., New Jersey), UCARCIDE™ (Union carbide Corp., Texas), VANCIDEO (R.T. Vanderbilt Co., Connecticut), PROXELO (ICI Americas, New Jersey), and combinations thereof.

Sequestering agents, such as EDTA (ethylene diamine tetra acetic acid), may be included to eliminate the deleterious effects of heavy metal impurities, and buffer solutions may be used to control the pH of the fluid. From about 0.01 wt % to about 2 wt %, for example, can be used. Viscosity modifiers and buffers may also be present, as well as other additives to modify properties of the fluid as desired. Such additives can be present at from about 0.01 wt % to about 20 wt %.
Liquid Oils

Turning now to the liquid oil that can be applied, as mentioned, the liquid oil can include a long-chain molecule having a carbon chain (branched or straight-chained) from about C₁₂ to about C₁₀₀, from about C₁₂ to about C₄₈, from about C₁₂ to about C₃₄, from about C₁₈ to about C₄₈, or from about C₁₈ to about C₃₄. For example, the liquid oil can include a C₁₂ to about C₁₀₀ straight-chain alkane, a C₁₂ to about C₁₀₀ branched alkane, a silicone oil having an alkyl side group, or a combination thereof. The liquid oil can be applied by soaking, for example, at a temperature from about 0° C. to about 150° C. , from about 10° C. to about 75° C., or from about 15° C. to about 35° C. Application can occur for periods of time from about 4 hours to about 1 month, from about 8 hours to about 1 month from about 10 hours to about 3 weeks, from about 10 hours to about 2 weeks, or from about 12 hours to about 1 week.

The liquid oil can be applied using an application unit, which can include equipment for applying liquid oil to a three-dimensional printed object. A liquid oil application unit can include a tank or well containing liquid oil for dipping a three-dimensional printed object or sprayers for spraying liquid oil onto a three-dimensional printed object. In certain examples, a liquid oil application unit can include a chamber in which a three-dimensional object can be enclosed and internal sprayers within the chamber can apply the liquid oil to the three-dimensional printed object. Thus, the term “soaking” does not infer that the three-dimensional object is being bathed in oil (though it may be), but rather that a coating of oil is applied and remains on a surface of the three-dimensional object for the time period of the soaking so that the oil can absorb into the surface during the soaking duration.

In further examples, it can be useful to wash excess liquid oil off of the three-dimensional printed object after soaking by whatever soaking method is used. The liquid oil application unit can also include equipment to wash the object, such as with soap and water. Alternatively, the three-dimensional printed object can be removed from the liquid oil application unit and washed elsewhere. In certain examples, a separate washing unit can be used.

Focusing on the liquid oil specifically, the liquid oil can include a variety of oils that include long-chain molecules having 12 carbon atoms or more. In some examples, the oil can include molecules having from 12 to 34 carbon atoms. It is noted that some oils include a mixture of many different compounds, and some compounds in the oil can fall outside of this range. However, a portion of the oil can be made up of molecules having from 12 to 34 carbon atoms. In various examples, the liquid oil can include a C₁₂ to about C₁₀₀ straight-chain alkane or a C₁₂ to about C₁₀₀ branched alkane. Additionally, in some examples, the liquid oil can be a silicone oil that includes carbon atom-containing side groups. Examples can include polymethylhydrosiloxane, polydimethylsiloxane, polydiethylsiloxane, and others.

In some examples, the liquid oil can include alkanes having from 12 carbon atoms to 34 carbon atoms. In other examples, the liquid oil can include alkanes having from 18 carbon atoms to 34 carbon atoms. In certain examples, the alkanes having from 18 carbon atoms to 34 carbon atoms can make up from about 50 wt % to 100 wt % of the total weight of the liquid oil. Examples of alkanes that can be included in the liquid oil can include n-dodecane, n-tridecane, n-tetradecane, n-pentadecane, n-hexadecane, n-heptadecane, n-octadecane, n-nanodecane, n-icosane, n-henicosane, n-docosane, n-tricosane, n-tetracosane, n-pentacosane, n-hexacosane, n-heptacosane, n-octacosane, n-nonacosane, n-triacontane, n-hentriacontane, n-dotriacontane, n-tritriacontane, n-tetratriacontane, hexylcyclohexane, heptylcyclohexane, octylcyclohexane, nonylcyclohexane, decylcyclohexane, undecylcyclohexane, dodecyclohexane, 3-methyl-1-hexylcyclohexane, 1-ethyl-2-hexylcyclohexane, 1-tert-butyl-4-hexylcyclohexane, and others. A variety of other branched alkanes can be included in the liquid oil.

In certain examples, the liquid oil can include motor oil. Motor oil is a mixture of compounds used as a lubricant for automotive engines. Many types of motor oil include 50 wt % or more of long-chain molecules having 12 carbon atoms or more, as described above. Examples of motor oils that can be used include non-synthetic motor oil, synthetic blends, and full-synthetic motor oil. Motor oils are available in a variety of weights and viscosities, such as 5W-20, 10W-30, etc.
Other Fluid Agents

In some more specific examples, in addition to the fusing agent and the liquid oil, there may be other fluid agents used, such as coloring agents, detailing agents or the like. A coloring agent may include a liquid vehicle and a colorant, such as a pigment and/or a dye. On the other hand, the three-dimensional printing kits can include a detailing agent. The detailing agent can include a detailing compound. The detailing compound can be capable of reducing the temperature of the particulate build material onto which the detailing agent is applied. In some examples, the detailing agent can be printed around the edges of the portion of the powder that is printed with the fusing agent. The detailing agent can increase selectivity between the fused and unfused portions of the powder bed by reducing the temperature of the powder around the edges of the portion to be fused.

In some examples, the detailing compound can be a solvent that evaporates at the temperature of the powder bed. In some cases the powder bed can be preheated to a preheat temperature within about 10° C. to about 70° C. of the fusing temperature of the polyamide-12 particles. Depending on the type of polyamide-12 particles used, the preheat temperature can be in the range of about 90° C. to about 200° C. or more. The detailing compound can be a solvent that evaporates when it comes into contact with the powder bed at the preheat temperature, thereby cooling the printed portion of the powder bed through evaporative cooling. In certain examples, the detailing agent can include water, co-solvents, or combinations thereof. Non-limiting examples of co-solvents for use in the detailing agent can include xylene, methyl isobutyl ketone, 3-methoxy-3-methyl-1-butyl acetate, ethyl acetate, butyl acetate, propylene glycol monomethyl ether, ethylene glycol mono tert-butyl ether, dipropylene glycol methyl ether, diethylene glycol butyl ether, ethylene glycol monobutyl ether, 3-Methoxy-3-Methyl-1-butanol, isobutyl alcohol, 1,4-butanediol, N,N-dimethyl acetamide, and combinations thereof. In some examples, the detailing agent can be mostly water. In a particular example, the detailing agent can be about 85 wt % water or more. In further examples, the detailing agent can be about 95 wt % water or more. In still further examples, the detailing agent can be substantially devoid of radiation absorbers. That is, in some examples, the detailing agent can be substantially devoid of ingredients that absorb enough radiation energy to cause the powder to fuse. In certain examples, the detailing agent can include colorants such as dyes or pigments, but in small enough amounts that the colorants do not promote fusion of the powder printed with the detailing agent when exposed to the radiation energy.

The detailing agent can also include ingredients to allow the detailing agent to be jetted by a fluid jet printhead. In some examples, the detailing agent can include jettability imparting ingredients such as those in the fusing agent described above. These ingredients can include a liquid vehicle, surfactant, dispersant, co-solvent, biocides, viscosity modifiers, materials for pH adjustment, sequestering agents, preservatives, and so on. These ingredients can be included in any of the amounts described above.

### Three-dimensional Printed Objects

A three-dimensional printed object prepared using the three-dimensional printing kits and/or methods described herein is shown in FIG. 3 at 150. For example, a three-dimensional printed object can include a polymeric body 145 including fused polyimide-12 particles having radiation absorber embedded as particles among the fused polyimide-12 particles (see FIG. 2 for fused polyimide-12 particles and radiation absorber). The three-dimensional printed object can also include a liquid oil 135 soaked into a surface of the polymeric body. The liquid oil can include a long-chain molecule having a carbon chain of about C₁₂ to about C₁₀₀. The three-dimensional printed object can exhibit a percent strain at break that is more than twice that of a control three-dimensional printed object prepared identically but without soaking in the liquid oil. The three-dimensional printed object can, in some examples, exhibit a 150% strain at break or greater after soaking, e.g., from about 150% to about 500%, from about 150% to about 300%, from about 200% to about 400%, or from about 225% to about 350%. Though the liquid oil is shown having soaked in to the polymeric body a certain depth, this is shown by way of example only. In some examples, the liquid oil may soak less than or deeper into the polymeric body, depending on the porous nature of the polymeric body, the liquid oil used, the amount of soaking time, the temperature, etc.

### Methods of Enhancing the Ductility of Three-dimensional Printed Objects

In further detail, a method of enhancing the ductility of a three-dimensional printed object is shown in FIG. 4 at 400, and can include soaking 410 a three-dimensional printed object in a liquid oil at a temperature from about 0° C. to about 150° C. for a period of time of about 4 hours to about 1 month. The liquid oil can include a long-chain molecule having a carbon chain (branched or straight-chained) from about C₁₂ to about C₁₀₀, from about C₁₂ to about C₄₈, from about C₁₂ to about C₃₄, from about C₁₈ to about C₄₈, or from about C₁₈ to about C₃₄, for example. The three-dimensional printed object can include fused polyimide-12 particles having radiation absorber embedded as particles among the fused polyimide-12 particles. In one example, the liquid oil can include a C₁₂ to C₁₀₀ straight-chain alkane, a C₁₂ to about C₁₀₀ branched alkane, a silicone oil having an alkyl side group, or a combination thereof. In another example, the radiation absorber can be selected from carbon black pigment, metal dithiolene complex, a near-infrared absorbing dye, a near-infrared absorbing pigment, metal nanoparticles, a conjugated polymer, tungsten bronze, molybdenum bronze, or a combination thereof. The three-dimensional printed object can include the radiation absorber in an amount from about 0.005 wt % to about 5 wt % with respect to the total weight of the three-dimensional printed object. The three-dimensional printed object can likewise exhibit a percent strain at break that is more than twice that of a control three-dimensional printed object prepared identically but without soaking in the liquid oil. In one example, the method can further include washing the surface of the three-dimensional printed object after applying the liquid oil. The liquid oil, in another example, can be applied at a temperature from about 15° C. to about 35° C. Regarding preparation of the three-dimensional printed object, the object can be prepared by iteratively applying individual build material layers of polyimide-12 particles to a powder bed, and based on a three-dimensional object model, selectively applying a fusing agent onto the individual build material layers, wherein the fusing agent comprises water and the radiation absorber. The preparation of the three-dimensional object can further include exposing the powder bed to energy to selectively fuse the polyamide-12 particles in contact with the radiation absorber to form the fused polyimide-12 particles having the radiation absorber embedded as particles at individual build material layers.

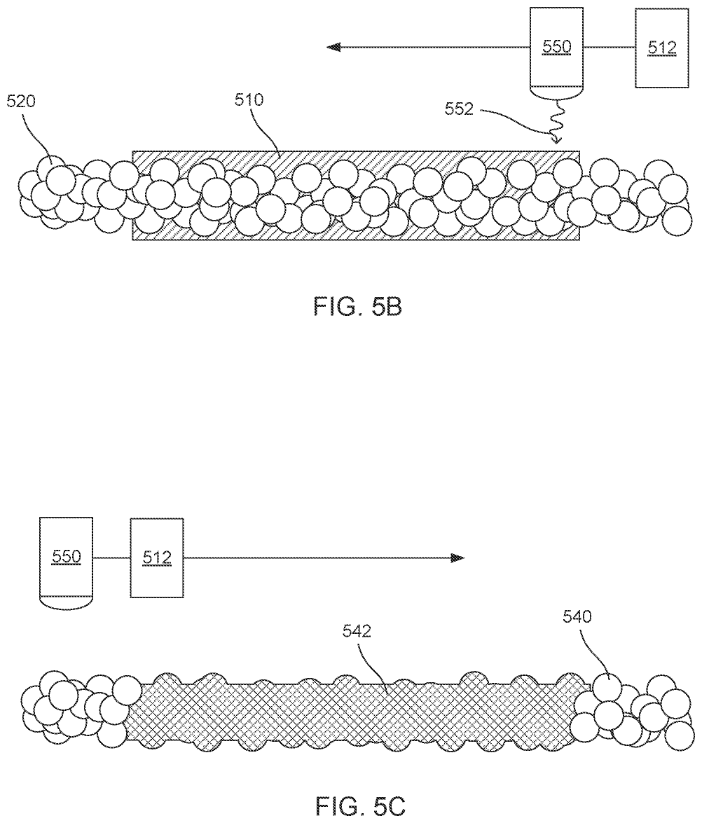

To illustrate the process of forming the three-dimensional printed object, FIGS. 5A-5C illustrate an example system, e.g., illustrating one example method that can be used to form a three-dimensional printed object prior to soaking in the liquid oil. In FIG. 5A, a fusing agent 510 is applied, e.g., jetted, onto a layer of particulate build material 520, which is part of a powder bed including the polyamide-12 particles. The fusing agent is jetted from a fusing agent ejector 512 that can move across the layer of particulate build material to selectively jet fusing agent on areas that are to be fused. A radiation source 550 is also shown, which is described in more detail in the context of FIG. 5B.

The system 500 is further described in FIG. 5B, which shows the layer of particulate build material 520 after the fusing agent 510 has been jetted onto an area of the layer that is to be fused. In this figure, the radiation source 550 is shown emitting radiation 552 toward the layer of polymeric build material, which includes the polyamide-12 particles. The fusing agent can include any of the radiation absorbers previously described, provided it can absorb this radiation and convert the radiation energy to heat.

FIG. 5C shows a layer of particulate build material 520 with a fused portion 542 where the fusing agent was jetted. This portion has reached a sufficient temperature to fuse the particulate build material (including the polyamide-12 particles) together to form a solid polymer matrix. For context, the fusing agent ejector 512 and the radiation source 550 are shown in place to apply the next applications of fusing agent and radiation to the next layer of particulate build material applied thereon, to thereby continue to build the three-dimensional object iteratively.

In some examples, a detailing agent or some other agent (not shown) can also be jetted onto the powder bed. The detailing agent, for example, can be a fluid that reduces the maximum temperature of the polyimide-12 particles on which the detailing agent is printed. In particular, the maximum temperature reached by the powder during exposure to radiation energy can be less in the areas where the detailing agent is applied. In certain examples, the detailing agent can include a solvent that evaporates from the polyimide-12 particles to evaporatively cool the polyamide-12 particles. The detailing agent can be printed in areas of the powder bed where fusing is not desired. In particular examples, the detailing agent can be printed along the edges of areas where the fusing agent is printed. This can give the fused layer a clean, defined edge where the fused polyimide-12 particles end and the adjacent polyimide-12 particles remain unfused. In other examples, the detailing agent can be printed in the same area where the fusing agent is printed to control the temperature of the area to be fused. In certain examples, some areas to be fused can tend to overheat, especially in central areas of large fused sections. To control the temperature and avoid overheating (which can lead to melting and slumping of the build material), the detailing agent can be applied to these areas

The fusing agent and, in some cases, detailing agent can be applied onto the powder bed using fluid jet print heads, e.g., jetting or ejecting from printing architecture. The amount of the fusing agent used can be calibrated based the concentration of radiation absorber in the fusing agent, the level of fusing desired for the polyamide-12 particles, and other factors. In some examples, the amount of fusing agent printed can be sufficient to contact the radiation absorber with the entire layer of polyamide-12 particles. For example, if individual layers of polyamide-12 particles are 100 microns thick, then the fusing agent can penetrate 100 microns into the polyimide-12 particles. Thus, the fusing agent can heat the polyimide-12 particles throughout the layer so that the layer can coalesce and bond to the layer below. After forming a solid layer, a new layer of loose powder can be formed, either by lowering the powder bed or by raising the height of a powder roller and rolling a new layer of powder.

In some examples, the powder bed, as a whole, can be preheated to a temperature below the melting or softening point of the polyamide-12 particles. In one example, the preheat temperature can be from about 10° C. to about 30° C. below the melting or softening point. In another example, the preheat temperature can be within 50° C. of the melting or softening point. In a particular example, the preheat temperature can be from about 160° C. to about 170° C. and the polyimide-12 particles can be polyimide-12 particles. In another example, the preheat temperature can be about 90° C. to about 100° C. and the polyamide-12 particles can be thermoplastic polyurethane. Preheating can be accomplished with a lamp or lamps, an oven, a heated support bed, or other types of heaters. In some examples, the entire powder bed can be heated to a substantially uniform temperature.

The powder bed can be irradiated with a fusing lamp. Suitable fusing lamps for use in the methods described herein can include commercially available infrared lamps and halogen lamps. The fusing lamp can be a stationary lamp or a moving lamp. For example, the lamp can be mounted on a track to move horizontally across the powder bed. Such a fusing lamp can make multiple passes over the bed depending on the amount of exposure to coalesce printed layers. The fusing lamp can be configured to irradiate the entire powder bed with a substantially uniform amount of energy. This can selectively coalesce the printed portions with fusing agent leaving the unprinted portions of the polyamide-12 particles below the melting or softening point.

In one example, the fusing lamp can be matched with the radiation absorber in the fusing agent so that the fusing lamp emits wavelengths of light that match the peak absorption wavelengths of the radiation absorber. A radiation absorber with a narrow peak at a particular near-infrared wavelength can be used with a fusing lamp that emits a narrow range of wavelengths at approximately the peak wavelength of the radiation absorber. Similarly, a radiation absorber that absorbs a broad range of near-infrared wavelengths can be used with a fusing lamp that emits a broad range of wavelengths. Matching the radiation absorber and the fusing lamp in this way can increase the efficiency of coalescing the polyimide-12 particles with the fusing agent printed thereon, while the unprinted polyimide-12 particles do not absorb as much light and remain at a lower temperature.

Depending on the amount of radiation absorber present in the polyimide-12 particles, the absorbance of the radiation absorber, the preheat temperature, and the melting or softening point of the polymer, an appropriate amount of irradiation can be supplied from the fusing lamp. In some examples, the fusing lamp can irradiate individual layers from about 0.5 to about 10 seconds per pass,

The three-dimensional printed object can be formed by jetting a fusing agent onto layers of powder bed build material according to a 3D object model. 3D object models can in some examples be created using computer aided design (CAD) software. 3D object models can be stored in any suitable file format. In some examples, a three-dimensional printed object as described herein can be based on a single 3D object model. The 3D object model can define the three-dimensional shape of the article. Other information may also be included, such as structures to be formed of additional different materials or color data for printing the article with various colors at different locations on the article. The 3D object model may also include features or materials specifically related to jetting fluids on layers of particulate build material, such as the desired amount of fluid to be applied to a given area. This information may be in the form of a droplet saturation, for example, which can instruct a three-dimensional printing system to jet a certain number of droplets of fluid into a specific area. This can allow the three-dimensional printing system to finely control radiation absorption, cooling, color saturation, and so on. All this information can be contained in a single 3D object file or a combination of multiple files. The three-dimensional printed object can be made based on the 3D object model. As used herein, “based on the 3D object model” can refer to printing using a single 3D object model file or a combination of multiple 3D object models that together define the article. In certain examples, software can be used to convert a 3D object model to instructions for a three-dimensional printer to form the article by building up individual layers of build material.

In an example of the three-dimensional printing process, a thin layer of polyimide-12 particles can be spread on a bed to form a powder bed. At the beginning of the process, the powder bed can be empty because no polyamide-12 particles have been spread at that point, or the first layer can be applied onto an existing powder bed, e.g., support powder that is not used to form the three-dimensional object. For the first layer, the polyamide-12 particles can be spread onto an empty build platform. The build platform can be a flat surface made of a material sufficient to withstand the heating conditions of the three-dimensional printing process, such as a metal. Thus, “applying individual build material layers of polyamide-12 particles to a powder bed” includes spreading polyamide-12 particles onto the empty build platform for the first layer. In other examples, a number of initial layers of polyamide-12 particles can be spread before the printing begins. These “blank” layers of particulate build material can in some examples number from about 10 to about 500, from about 10 to about 200, or from about 10 to about 100. In some cases, spreading multiple layers of powder before beginning the printing can increase temperature uniformity of the three-dimensional printed object. A fluid jet printing head, such as an inkjet print head, can then be used to print a fusing agent including a radiation absorber over portions of the powder bed corresponding to a thin layer of the 3D article to be formed. Then the bed can be exposed to electromagnetic energy, e.g., typically the entire bed. The electromagnetic energy can include light, infrared radiation, and so on. The radiation absorber can absorb more energy from the electromagnetic energy than the unprinted powder. The absorbed light energy can be converted to thermal energy, causing the printed portions of the powder to soften and fuse together into a formed layer. After the first layer is formed, a new thin layer of polyamide-12 particles can be spread over the powder bed and the process can be repeated to form additional layers until a complete 3D article is printed. Thus, “applying individual build material layers of polyamide-12 particles to a powder bed” also includes spreading layers of polyamide-12 particles over the loose particles and fused layers beneath the new layer of polyamide-12 particles.

After the three-dimensional object has been initially formed using the process described above, the object can be treated with a liquid oil using any of the application methods described above. For example, the object can be dipped in liquid oil for a period of time as shown in FIG. 2. In further examples, the method can also include washing excess liquid oil off of the three-dimensional printed object, such as using soap and water. In various examples, the object can be washed by spraying with soap and water, soaking, scrubbing, or other methods.

As explained above, the three-dimensional printed object can have a darker black appearance after the treatment with the liquid oil compared to before the treatment. In some examples, the dark black appearance can be indicated by an L* value that is lower than the L* value before the treatment. In certain examples, the three-dimensional printed object can have an L* value from about 35 to about 50 before the liquid oil treatment and a reduced L* value from about 15 to about 35 after the liquid oil treatment.
Definitions

It is noted that, as used in this specification and the appended claims, the singular forms “a,” “an,” and “the” include plural referents unless the content clearly dictates otherwise,

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, “kit” can be synonymous with and understood to include a plurality of multiple components where the different components can be separately contained (though in some instances co-packaged in separate containers) prior to use, but these components can be combined together during use, such as during the three-dimensional object build processes described herein. The containers can be any type of a vessel, box, or receptacle made of any material.

As used herein, “applying” when referring to a fluid agent that may be used, for example, refers to any technology that can be used to put or place the fluid, e.g., fusing agent, fluid recycling agent, detailing agent, coloring agent, or the like on the polymeric build material or into a layer of polymeric build material for forming a three-dimensional object. For example, “applying” may refer to a variety of dispensing technologies, including “jetting,” “ejecting,” “dropping,” “spraying,” or the like.

As used herein, “jetting” or “ejecting” refers to fluid agents or other compositions that are expelled from ejection or jetting architecture, such as ink-jet architecture. Ink-jet architecture can include thermal or piezoelectric architecture. Additionally, such architecture can be configured to print varying drop sizes such as up to about 20 picoliters, up to about 30 picoliters, or up to about 50 picoliters, etc. Example ranges may include from about 2 picoliters to about 50 picoliters, or from about 3 picoliters to about 12 picoliters.

As used herein, “average particle size” refers to a number average of the diameter of the particles for spherical particles, or a number average of the volume equivalent sphere diameter for non-spherical particles. The volume equivalent sphere diameter is the diameter of a sphere having the same volume as the particle. Average particle size can be measured using a particle analyzer such as the MASTERSIZER™ 3000 available from Malvern Panalytical (United Kingdom). The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, a plurality of items, structural elements, compositional elements, and/or materials may be presented in a common list for convenience. However, these lists should be construed as though the individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates examples of the present disclosure. However, it is to be understood that the following are merely illustrative of the application of the principles of the present disclosure. Numerous modifications and alternative devices, methods, and systems may be devised without departing from the spirit and scope of the present disclosure. The appended claims are intended to cover such modifications and arrangements.

### Treating Three-dimensional Printed Objects

Twelve sample three-dimensional objects were printed in the shape of dog bones using an HP Multi-jet Fusion 3D® printer. The build material was polyimide-12 powder and the fusing agent included carbon black pigment as a radiation absorber. The twelve sample dog bones were divided in three groups of four objects. Four of the dog bones were soaked by complete immersion for 100 hours in SAE 30 motor oil at room temperature. Four of the dog bones were soaked similarly in a waxy grease for 100 hours at room temperature. Four of the dog bones were set aside and not soaked in anything as a control.

TABLE 1
Mechanical Properties

| | | Tensile | Young's | % Strain |
|---|---|---|---|---|
| Specimen ID | Treatment | Strength (MPa) | Modulus (MPa) | at Break |
| Dog Bone 1 | Motor Oil | 46.24 | 1556.59 | 299.41 |
| Dog Bone 2 | Motor Oil | 47.3 | 1650.73 | 281.67 |
| Dog Bone 3 | Motor Oil | 45.24 | 1635.55 | 228.12 |
| Dog Bone 4 | Motor Oil | 46.86 | 1705.31 | 272.42 |
| Average | | 46.41 | 1637.045 | 270.405 |
| Dog Bone 5 | Grease | 51.1 | 1863.99 | 252.87 |
| Dog Bone 6 | Grease | 50.78 | 1859.36 | 47.13 |
| Dog Bone 7 | Grease | 50.94 | 1917.93 | 227.05 |
| Dog Bone 8 | Grease | 50.71 | 2082.51 | 52.65 |
| Average | | 50.88 | 1930.95 | 144.93 |
| Dog Bone 9 | None | 50.5 | 1867.21 | 79.3 |
| Dog Bone 10 | None | 48.82 | 1821.74 | 74.56 |
| Dog Bone 11 | None | 47.27 | 1920.9 | 220.64 |
| Dog Bone 12 | None | 48.64 | 1791.57 | 58.34 |

| | | | |
|---|---|---|---|
| Average | 48.81 | 1850.36 | 108.21 |

As can be seen in Table 1, the mechanical properties data confirms slight reduction in Young's modulus, but significantly improved ductility as evidenced by the % Strain at break data for the dog bones soaked in engine oil for 100 hours at room temperature. Compared to the % strain at break data collected for the dog bones not treated with the motor oil, there was about a 250% improvement on average across the four samples prepared in each group. The sample soaked in grease surprisingly did not offer the same magnitude of ductility improvement, e.g., only about 133% improvement on average.

Furthermore, the same experiment was conducted with polyamide-11 as the polymeric build material, and there was no significant difference in ductile strength compared to the dog bones that were not soaked in liquid oil. Thus, the combination of ductility improvement with polyimide-12 as the base polymeric build material was unexpected compared to use of a similar polymer (polyimide-11). It is possible that the porosity of three-dimensional objects prepared using polyamide-12 particles may be more effective in receiving the liquid oil during soaking than may be the case with other polyimide particles such as polyimide-11.

What is claimed is:

1. A three-dimensional printing kit comprising:
a fusing agent comprising:
from about 75 wt % to about 99 wt % water, and
from about 0.1 wt % to about 15 wt % radiation absorber;
a polymeric build material including polyimide-12 particles; and
a liquid oil comprising from about 50 wt % to 100 wt % of a long-chain molecule having a carbon chain of about C₁₂ to about C₁₀₀.

2. The three-dimensional printing kit of claim 1, wherein the liquid oil comprises a C₁₂ to about C₁₀₀ straight-chain alkane, a C₁₂ to about C₁₀₀ branched alkane, a silicone oil having an alkyl side group, or a combination thereof.

3. The three-dimensional printing kit of claim 1, wherein the liquid oil comprises from about 50 wt % to 100 wt % of a C₁₈ to C₄₈ alkane or a polydimethylsiloxane.

4. The three-dimensional printing kit of claim 1, wherein the radiation absorber is selected from carbon black pigment, metal dithiolene complex, a near-infrared absorbing dye, a near-infrared absorbing pigment, metal nanoparticles, a conjugated polymer, tungsten bronze, molybdenum bronze, or a combination thereof.

5. A three-dimensional printed object, comprising:
a polymeric body including fused polyamide-12 particles having radiation absorber embedded as particles among the fused polyamide-12 particles; and
a liquid oil soaked into a surface of the polymeric body, wherein the liquid oil comprises a long-chain molecule having a carbon chain of about C₁₂ to about C₁₀₀,
wherein three-dimensional printed object exhibits a percent strain at break that is more than twice that of a control three-dimensional printed object prepared identically but without soaking in the liquid oil,

6. The three-dimensionally printed object of claim 5, wherein liquid oil is soaked into a surface a three-dimensional printed object at a temperature from about 0° C. to about 150° C. for a period of time of about 4 hours to about 1 month.

7. The three-dimensionally printed object of claim 5, wherein three-dimensional printed object exhibits a 150% strain at break or greater after soaking.

8. A method of enhancing ductility of a three-dimensional printed object comprising soaking a three-dimensional printed object in a liquid oil at a temperature from about 0° C. to about 150° C. for a period of time of about 4 hours to about 1 month, wherein the liquid oil comprises a long-chain molecule having a carbon chain of about C₁₂ to about C₁₀₀, wherein the three-dimensional printed object comprises fused polyamide-12 particles having radiation absorber embedded as particles among the fused polyimide-12 particles.

9. The method of claim 8, wherein the liquid oil comprises a C₁₂ to about C₁₀₀ straight-chain alkane, a C₁₂ to about C₁₀₀ branched alkane, a silicone oil having an alkyl side group, or a combination thereof. The method of claim 8, wherein the radiation absorber is selected from carbon black pigment, metal dithiolene complex, a near-infrared absorbing dye, a near-infrared absorbing pigment, metal nanoparticles, a conjugated polymer, tungsten bronze, molybdenum bronze, or a combination thereof.

11. The method of claim 8, wherein the three-dimensional printed object includes the radiation absorber in an amount from about 0.005 wt % to about 5 wt % with respect to the total weight of the three-dimensional printed object.

12. The method of claim 8 ; wherein three-dimensional printed object exhibits a percent strain at break that is more than twice that of a control three-dimensional printed object prepared identically but without soaking in the liquid oil. 13, The method of claim 8, further comprising washing the surface of the thee-dimensional printed object after applying the liquid oil.

14. The method of claim 8, wherein the liquid oil is applied at a temperature from about 15° C. to about 35° C.

15. The method of claim 8, wherein prior to soaking in the liquid oil; the three-dimensional printed object is prepared by:
iteratively applying individual build material layers of polyimide-12 particles to a powder bed;
based on a three-dimensional object model, selectively applying a fusing agent onto the individual build material layers, wherein the fusing agent comprises water and the radiation absorber; and
exposing the powder bed to energy to selectively fuse the polyimide-12 particles in contact with the radiation absorber to form the fused polyimide-12 particles having the radiation absorber embedded as particles at individual build material layers.
